(19) United States
(12) Patent Application Publication
(10) Pub. No.: US 2020/0074232 A1
(43) Pub. Date: Mar. 5, 2020

(54) COLLECTING DATA OBJECTS FROM MULTIPLE SOURCES

(71) Applicant: Element AI Inc., Montreal (CA)

(72) Inventors: Marat GUBAIDULLIN, Montreal (CA); Simon MAXWELL-STEWART, Montreal (CA); Paul GAGNON, Montreal (CA)

(21) Appl. No.: 16/555,247

(22) Filed: Aug. 29, 2019

Related U.S. Application Data
(60) Provisional application No. 62/724,740, filed on Aug. 30, 2018.

(51) Int. Cl. G06K 9/62; G06N 20/00; G06F 16/906; G06Q 30/02

(52) U.S. Cl. CPC G06K 9/6257; G06K 9/6263; G06Q 30/0208; G06F 16/906; G06N 20/00

(57) ABSTRACT

Systems and methods for collecting data from multiple sources. A server receives a data request for desired content from a requestor. The server generates a request for data objects containing that content and displays that request to at least one potential data provider. The at least one data provider provides a data object in response to the request. In some embodiments, the data provider may label the provided data object. In further embodiments, labels may replace sensitive personal information on the data. The data objects may be obtained by the data providers using their personal portable computing devices. In some embodiments, data providers may upload data objects that are not directed to a specific request. These data objects may then be associated with later data requests.

### RELATED APPLICATIONS

This application is a non-provisional patent application which claims benefit of U.S. Provisional Application No. 62/724,740 filed on Aug. 30, 2018.

### TECHNICAL FIELD

The present invention relates to collecting data. More specifically, the present invention relates to systems and methods for collecting data sets from many different sources.

### BACKGROUND

The explosion in interest in machine learning is a testament to how far machine learning has come since the baby step days of the late 20th century. Machine learning and artificial intelligence are now becoming more ubiquitous as they are used in everything from consumer products to business intelligence systems. One interesting offshoot in these developments is the rise of a market for something necessary for such systems: data.

As is well-known, machine learning systems, especially those that use supervised learning methods, require data and data sets so they can learn and be tested. Suitable data sets, depending on the task to be learned, can be expensive and/or difficult to obtain. For tasks involving business documents, data sets can be difficult to obtain as such documents might contain sensitive information that the owners of the documents would not want to be exposed to the world. Not only that, but given the amount of data that such machine learning systems might need to properly learn a task, obtaining and digitizing such a large amount of business documents is a daunting challenge.

In the field of machine learning, data sets suitable for training are required to ensure that systems accurately and properly accomplish their tasks. As an example, for systems that recognize cars within images, training data sets of labeled images containing cars are needed. Similarly, to train systems that, for example, track the number of trucks crossing a border, data sets of labeled images containing trucks are required.

As is known in the field, these labeled images are used so that, by exposing systems to multiple images of the same item in varying contexts, the systems can learn how to recognize that item. However, as is also known in the field, obtaining labeled images which can be used for training machine learning systems is not only difficult, it can also be quite expensive. In many instances, such labeled images are manually labeled, i.e., labels are assigned to each image by a person. Since data sets can sometimes include thousands of images, manually labeling these data sets can be a very time-consuming task.

Additionally, as is well-known, gathering large sets of data is frequently complicated by the presence of identifying information. For instance, images of receipts may contain sensitive personal or corporate information. The present difficulties raised by anonymizing large amounts of data often make large data sets hard to obtain.

Automatically generated data, moreover, may be created (e.g., automatically synthesized images). However, many current data synthesis techniques result in data that is ‘too perfect’—i.e., that is pristine and relatively unvaried. Machine learning systems trained on these ‘too perfect’ data sets often have trouble adjusting to real-world data, which is often ‘messy’.

From the above, there is therefore a need for systems and methods that can address the above need for voluminous amounts of real-world data for use with machine learning systems.

### SUMMARY

The present invention provides systems and methods for collecting data from multiple sources. A server receives a data request for desired content from a requestor. The server generates a request for data objects containing that content and displays that request to at least one potential data provider. The at least one data provider provides a data object in response to the request. In some embodiments, the data provider may label the provided data object. In further embodiments, labels may replace sensitive personal information on the data. The data objects may be obtained by the data providers using their personal portable computing devices. In some embodiments, data providers may upload data objects that are not directed to a specific request. These data objects may then be associated with later data requests.

In a first aspect, the present invention provides a method for collecting at least one data object containing desired content, steps comprising:
(a) receiving a data request for data objects containing said content;
(b) storing said data request in a first database;
(c) based on said data request, generating a request for said data objects;
(d) displaying said request for said data objects to at least one data provider;
(e) receiving said at least one data object from said at least one data provider in response to said request; and
(f) storing said data object in a second database.

In a second aspect, the present invention provides a method for collecting at least one desired data object containing desired content, said method comprising the steps of:
(a) receiving a data request for data objects containing said desired content;
(b) storing said data request in a first database;
(c) searching a second database for at least one data object containing said desired content; and
(d) retrieving said at least one data object from said second database,
wherein:
said at least one data object is provided by a data provider;
said at least one data object has at least one label; and
said at least one label indicates said a presence of said desired content in said at least one data object.

In a third aspect, the present invention provides a system for collecting at least one data object containing desired content, said system comprising:
a server for:
   receiving a data request for data objects containing said desired content;
   displaying a request for said data objects to at least one data provider;
   receiving said at least one data object from said at least one data provider in response to said request;
a request database in operative communication with said server, said request database being for storing said data request; and
a data object database in operative communication with said server, said data object database being for storing said at least one data object.

In a fourth aspect, the present invention provides non-transitory computer-readable media having encoded thereon computer-readable and computer-executable instructions that, when executed, implement a method for collecting at least one data object containing desired content, steps comprising:
(a) receiving a data request for data objects containing said content;
(b) storing said data request in a first database;
(c) based on said data request, generating a request for said data objects;
(d) displaying a request for said data objects to at least one data provider;
(e) receiving said at least one data object from said at least one data provider in response to said request; and
(f) storing said data object in a second database.

In a fifth aspect, the present invention provides non-transitory computer-readable media having encoded thereon computer-readable and computer-executable instructions that, when executed, implement a method for collecting at least one desired data object containing desired content, said method comprising the steps of:
(a) receiving a data request for data objects containing said desired content;
(b) storing said data request in a first database;
(c) searching a second database for at least one data object containing said desired content; and
(d) retrieving said at least one data object from said second database,
wherein:
said at least one data object is provided by a data provider;
said at least one data object has at least one label; and
said at least one label indicates a presence of said desired content in said at least one data content.

### BRIEF DESCRIPTION OF THE DRAWINGS

The present invention will now be described by reference to the following figures, in which identical reference numerals refer to identical elements and in which:

FIG. 1 is a block diagram illustrating a system according to one aspect of the invention;

FIG. 2 is another block diagram, illustrating an embodiment of the system in FIG. 1;

FIG. 3 is a loading screen image from an application implementing the system of the present invention;

FIG. 4 is an image of a graphical user interface from the application of FIG. 3;

FIG. 5 is another image of the graphical user interface from the application of FIG. 3;

FIG. 6 is another image of the graphical user interface from the application of FIG. 3;

FIG. 7 is another image of the graphical user interface from the application of FIG. 3;

FIG. 8 is another image of the graphical user interface from the application of FIG. 3;

FIG. 9 is another image of the graphical user interface from the application of FIG. 3;

FIG. 10 is another image of the graphical user interface from the application of FIG. 3;

FIG. 11 is a flowchart detailing a method according to an aspect of the present invention;

FIG. 12 is a flowchart detailing an embodiment of the method in FIG. 11; and

FIG. 13 is another flowchart detailing an embodiment of the method in FIG. 11.

### DETAILED DESCRIPTION

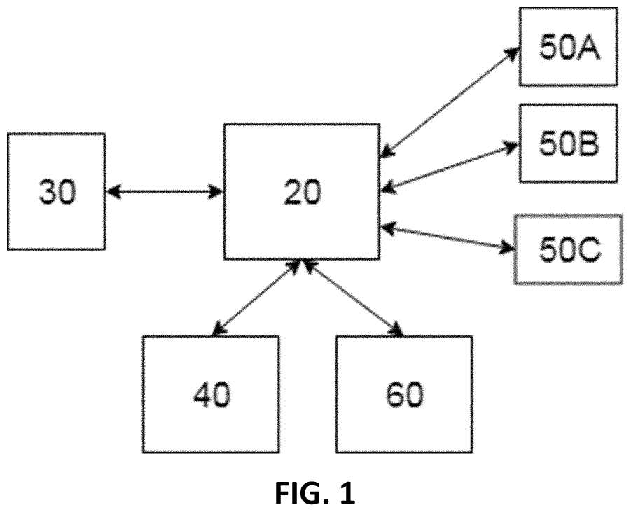

The present invention provides systems and methods for “crowd-sourcing” data. That is, the present invention provides systems and methods for collecting data objects from multiple sources, via a centralized system. Referring to FIG. 1, a system according to one aspect of the invention is illustrated. In the system 10, a server 20 receives a data request from a requestor 30. The data request indicates a certain type of desired content. The server 20 then stores that data request in a request database 40 and, based on the data request, generates a request for data objects containing the desired content. The server 20 then displays that request for data objects to at least one data provider 50A, 50B, and 50C. At least one of the data providers responds to the request for data objects by providing a data object containing the desired content. The data object is then stored in an object database 60. Multiple data objects may be gathered in response to a single request for data objects. The multiple data objects can be grouped together to form a data set.

The data requestor indicates the desired type of data object when making the initial data request. The data objects requested may be data objects of any type, including but not limited to: text data; image data; image and text data; audio data; video data; unidimensional data; and multi-dimensional data. For efficiency, however, it is preferred that each data set comprise a single type of data objects.

Similarly, the desired content of the data objects to be gathered is indicated by the initial requestor. The content may be any content from any field. For instance, a data requestor may request images of shopping receipts, or may request audio recordings of lawn mower engines. For ease of collection, however, it is preferred that the data type be obtainable using conventional portable computing devices (such as cellular phones, tablets, laptop computers, etc.). Such data may thus be collected by a data provider using sensors on their personal portable computing devices, and easily connected to the server 20. As may be understood, the present invention may therefore comprise an application configured to work on personal portable computing devices and to communicate with the server 20.

In another embodiment, so-called ‘free-floating’ data objects may be uploaded by data providers. That is, a data provider may provide data objects that are not related to any current request for data objects. These free-floating data objects are stored in the object database 60. They may then be ‘picked up’ by a later data request and added to an appropriate data set (i.e., the server 20 searches the object database 60 for data objects that contain the desired content). In some cases, thus, a data set may comprise ‘free-floating’ data objects as well as data objects that are directly provided in response to a corresponding data request. In other cases, a data set may comprise only free-floating data objects.

Note that the server 20 searches the object database 60 for appropriate free-floating data objects by searching for data objects with labels that correspond to the desired content of a given data request. Thus, it is preferable that each free-floating data object has at least one label indicating its content.

Additionally, note that a data provider may not wish to allow any data request to access a provided data object. Thus, in some embodiments, the data provider may set one or more permission levels for each data object they provide. These permission levels may take many forms. As an example, a permission level could explicitly prevent certain requestors from accessing the data object in question. Additionally, a permission level could alert the data provider whenever a data request attempts to ‘pick up’ that data object. That alert could allow the data provider to allow or prevent the data request from picking up the data object. Another permission level could be time limited. For instance, a data object might only be accessible to data requests for a certain period of time. In another example, that data object might only be accessible to general data requests after a certain period of time has elapsed.

Further, in some embodiments, data providers may set permission levels for data objects that they directly provide in response to a request. For instance, the data provider may provide a data object that, based on the permission level, can only be used by a single specific request or requestor. The data provider could thus set a corresponding permission level. In other embodiments, permission levels may be set at a system level, rather than by individual data providers. Additionally, some permission levels may be set based on the kind of data object being provided or the permission levels may be based on the contents of the data objects. (For instance, on a system-wide basis, lower permission levels (i.e., fewer requestors/requests may use them) might be applied to images of people's faces when compared to permission levels for sound files of car engines.)

Again, it should be clear that many different forms of permission levels may be implemented, both for data objects provided in response to a given request and for free-floating data objects. The above examples merely list some possible kinds of permission levels, and nothing in the above examples should be taken as limiting the scope of the present invention in any way.

For further clarity, FIG. 1 is merely an exemplary block diagram. For visual simplicity, one data requestor 30 and three data providers 50A-50C are shown in FIG. 1. However, the server 20 may receive multiple requests from multiple requestors, and display the request for data objects to many data providers simultaneously. Additionally, of course, a single data requestor may make multiple data requests. Further, a single data provider may provide multiple data objects in response to a single request, and may provide data objects in response to multiple distinct data requests. As well, it should be noted that an individual may be both a data provider and a data requestor—that is, a single person may both submit a data request and respond to it, as well as to others.

Additionally, the server 20 may determine which data providers are permitted to see a certain request for data objects. For instance, a corporation with specific data needs may submit a data request for content to be gathered by its employees. As an example, a car manufacturer may wish to ask its line employees to submit pictures of defective brake pads. As part of its initial data request, the car manufacturer could restrict that data request to its line employees only.

As would be clear to the person skilled in the art, data objects collected in response to a single request may be grouped into a data set by associating a data set identifier with each of those data objects. The data set identifier may be a reference to the data request as stored in the request database. In some implementations, the request database 40 and the object database 60 may be in communication with each other. However, in other implementations, and in FIG. 1, the request database 40 and the object database 60 are not in direct communication with each other. Rather, communication between them is mediated by the server 20. As would also be clear, the server and the database may communicate using either wired or wireless methods. Further, in certain circumstances, the data provider(s) and the data requestor(s) may be in direct wired contact with the server 20. However, generally, the data provider(s) and the data requestor(s) will use their own personal portable computing devices that connect to the server 20 wirelessly.

The initial request from the data requestor may additionally comprise an amount request. The amount request is for a desired amount of the requested objects, and can be either a specific number or a threshold number. For example, a certain data request may include an amount request for 1000 data objects. In such a case, once 1000 data objects have been collected in response to a request, the request for data objects would be fulfilled and the server 20 would no longer display that request to data providers. In other cases, a data request may include a threshold-number amount request for at least 1000 data objects. In such a case, when 1000 data objects have been collected, the request would be fulfilled but would still be displayed to potential data providers, who may continue to provide data objects in response.

When the request for objects in fulfilled, the system 10 can send an alert to the requestor. The requestor can then access the stored data objects and download the data set from the server 20. Additionally, the requestor is able to audit individual data objects as they are submitted. Moreover, if the requestor so wishes, they are able to reject individual data objects and remove those data objects from the data set.

In some embodiments, data objects may be ranked based on their quality and/or on how many objects have been collected. That is, objectively ‘lower-quality’ data objects may be ranked highly if few data objects have been collected. The rank of such data objects will likely decrease as more data objects are added to the data set. Conversely, when many data objects have been collected, objectively ‘high-quality’ images may be ranked lower relative to other. The quality of data objects may be determined by automated processes, by humans, or by a combination thereof.

In some cases, the present invention can be ‘gamified’. That is, incentive programs may be developed to encourage data providers to provide data objects. Depending on the implementation, the data providers may be encouraged to provide high-quality data objects. Some incentives may be in-application incentives, while others may be offline (i.e., real-world) incentives.

The data requestor may access the collected data at any time, even before a request is fulfilled. Additionally, the data requestor may modify or cancel the request at any time. Data associated with a cancelled request is retained in the system, as some may be useful in other sets or applications.

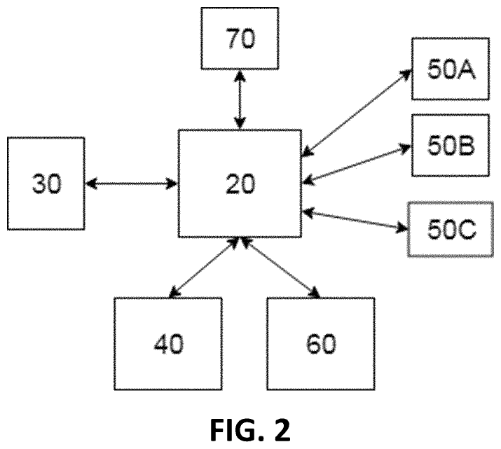

Referring now to FIG. 2, a system according to another embodiment of the invention is shown. As can be seen, FIG. 2 is very similar to FIG. 1. However, FIG. 2 includes a labeling module 70, which is connected to the server 20. The labeling module 70 allows a data provider to provide label input information to be associated with a data object. The label input information may indicate a general type of content, or may indicate a specific field or piece of data. For instance, if a data provider provides an image of a receipt, they may mark it as a ‘receipt’. They may also mark individual fields on the image (for instance by drawing a bounding box). In the receipt example, such fields might include ‘Company Name’, ‘Purchaser’, ‘Date’, ‘Total’, and so on. In some embodiments, the data provider can choose from a predetermined list of possible fields, provided by the data requestor. In other embodiments, the data provider may define new fields. Of course, in some cases, the data provider may choose some predetermined fields and define some new fields, depending on the input data.

Additionally, in some implementations, the labeling module 70 itself can provide label input information to be associated with data objects. Such implementations may use well-known techniques, including but not limited to optical character recognition, to derive information about the general type of content and/or the individual fields on each data object.

In some embodiments, the system 10 can replace the original data with the provided field name. Thus, instead of potentially sensitive information, a data object would contain only the field name. This replacement process allows data objects to be rendered anonymous, and therefore reduces security concerns associated with data sets.

In one embodiment, this data-replacing process occurs on the server 20. However, in a preferred embodiment, the data-replacing occurs on the data provider's personal computing device itself. In such an embodiment, the data provider's personal computing device may host an application that provides the functions of the labeling module 70. In this embodiment, data objects comprising potentially sensitive information would be rendered anonymous on the data provider's personal portable computing device. Thus, potentially sensitive information would not need to travel to the server 20 for any length of time.

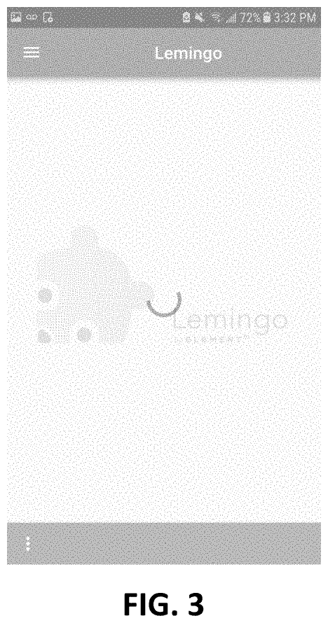

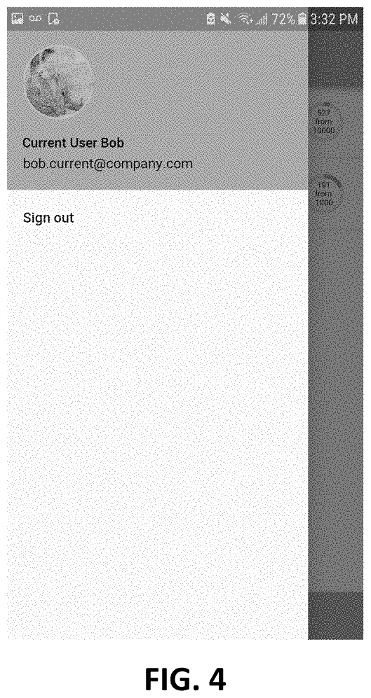

FIG. 3 shows a loading screen image from an application configured to implement the present invention. This application may be run on portable computing devices belonging to either the data provider(s) or the data requestor(s)—that is, a single application can fulfill both functions. Note that this application is merely one implementation of the present invention and should not be taken as limiting the invention in any way. FIG. 4 is an image of a user profile sidebar interface from the application of FIG. 3. Note that, in FIGS. 4 through 9, personally identifying information, corporate logos, and other potentially sensitive data points have been removed and/or obscured. As would be clear, in a real-world use of this application, this information would be visible to the data provider, and potentially to the data requestor. However, as mentioned above, in some implementations, the data provider may intentionally obscure sensitive data.

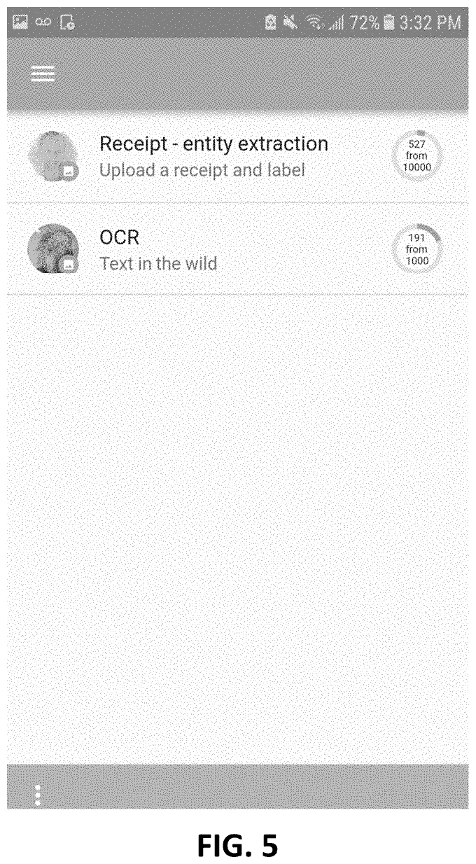

FIG. 5 shows a requests interface from the application of FIG. 3. This interface shows the requests for data objects to which the current user of the application has access. As can be seen, the current user is able to respond to two separate requests for data objects. One of the requests is titled “Receipt—entity extraction”, and has a descriptor reading “Upload a receipt and label”. The other request is titled “OCR”, and the given descriptor is “Text in the wild”. These titles and descriptors are provided by the requestors. Profile images representing the requestors are shown to the left of the title and descriptor. (It should be noted that a requestor is not required to upload an image, or even to identify himself or herself. Some data requestors may prefer that certain requests remain anonymous.) On the right of each request is a circle gauge, indicating how many data objects have been collected for each request. As can be seen, more data objects have been collected for the “Receipt—entity extraction” request than for the “OCR” request. However, the “Receipt—entity extraction” request will not be fulfilled until 10,000 data objects are received, while the OCR request will be fulfilled after 1000 data objects are received.

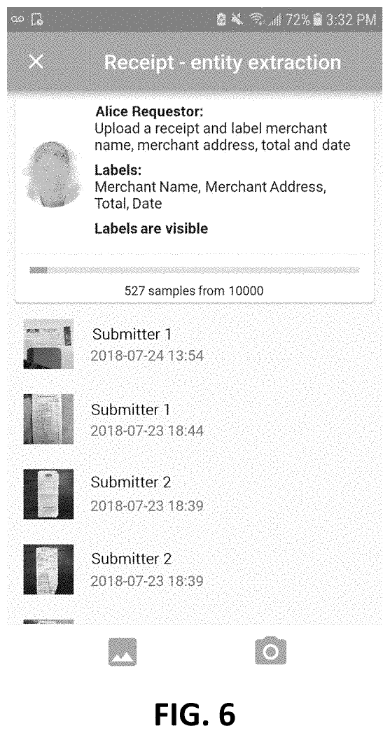

FIG. 6 shows a request detail interface from the application of FIG. 3. The request title is shown at the top of the screen, under which is a box containing detailed request information. This box contains the requestor's profile image and the requestor's name, in addition to more detailed request information and specific predetermined data fields that are to be labeled by the data provider. (Again, of course, the data requestor may prefer anonymity. The data requestor is not required to identify himself or herself.) At the bottom of the box is a progress bar indicating how close the data set is to fulfillment. As can be seen, this progress bar corresponds to the circle gauge in FIG. 5.

Underneath the detail box are data object previews. Each preview comprises a data object thumbnail, a provider name, and a timestamp indicating when the data object was submitted. The application user may scroll through the previews and/or select one to expand. In some implementations, these data object previews are only shown to the data requestor. In such implementations, a data provider would not be able to see data objects that have already been submitted in response to a request. Further, in some implementations, the data requestor may choose whether to make the data object previews public or to hide them from the data providers.

At the bottom of the screen, there are two icons. Selecting the picture icon on the left allows a data provider to upload a pre-stored photo from their device. Depending on the implementation and the type of data requested, of course, other data objects may be selected. The camera icon on the right allows the data provider to access an internal camera on their portable computing device, take a photo of the desired content (here, of a receipt), and directly upload it without saving it to their device. After the data provider has uploaded the data object to the application, they can use the labeling features to label fields and/or to replace sensitive personal information.

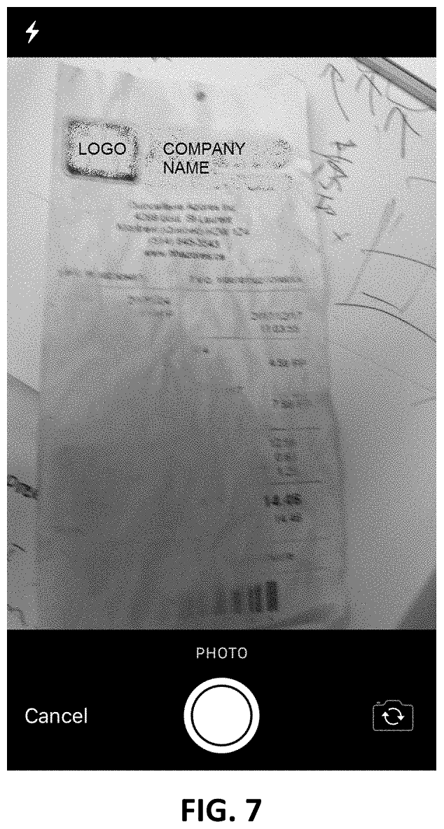

FIG. 7 is an image upload interface from the application of FIG. 3. This interface accesses the native camera application on the data provider's personal portable computing device. The data provider can then use the native camera application to capture a picture of the desired content. In this case, the desired content is a receipt. As should be clear, for this example, the company name and logo on this receipt have been obscured and replaced by “COMPANY NAME” and “LOGO”, respectively.

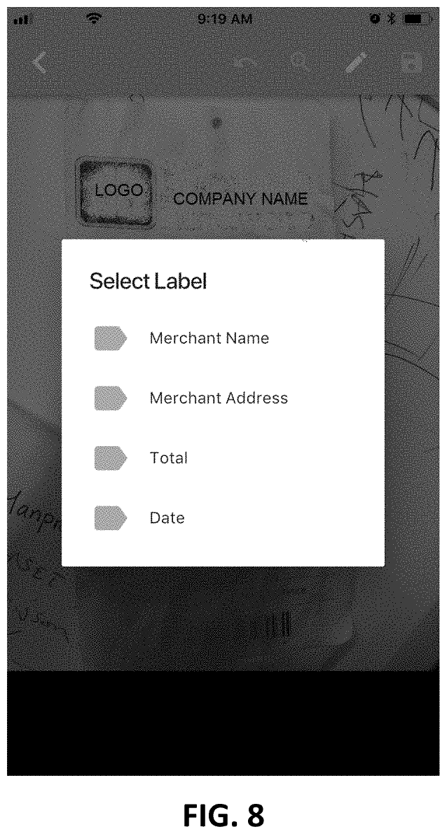

FIG. 8 is a label selection interface from the application of FIG. 3. Once a picture of the desired content has been captured, this label selection interface can be accessed by the pen icon in the blue bar at the top of the screen. This interface allows the data provider to label areas of the image as containing certain predetermined data fields. In this case, the predetermined data fields are “Merchant Name”, “Merchant Address”, “Total”, and “Date”. These data fields were determined by the initial data requestor. The data provider may choose to label the content image with some, none, or all of these data fields. To label the image, the data provider selects a field label name from the central box (e.g., “Merchant Address”).

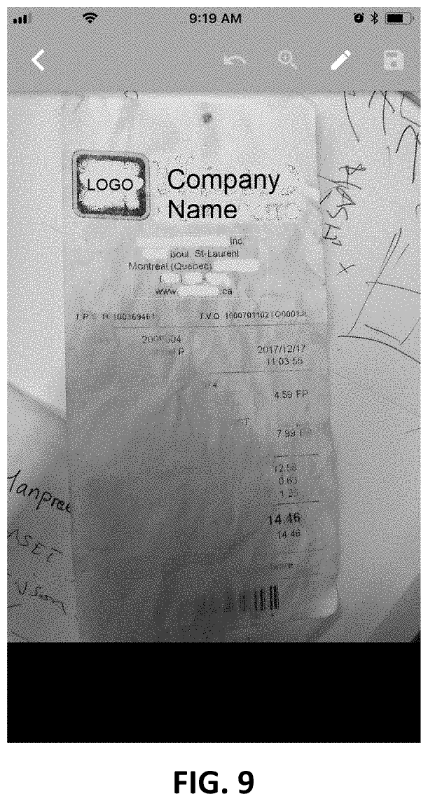

FIG. 9 shows a labeling interface from the application of FIG. 3, using the receipt image from FIGS. 7 and 8. As can be seen, the top bar of this interface contains several function buttons, including: “Back”; “Undo”; “Zoom”; “Draw”; and “Save/Upload”. The data provider has chosen to label the “Merchant Address” on this receipt image. They have drawn a bounding box around the address information using their portable computing device. They can adjust this bounding box and/or remove it if they wish. This bounding box will act as a field label and remain associated with this image once the data provider uploads the image to the server 20.

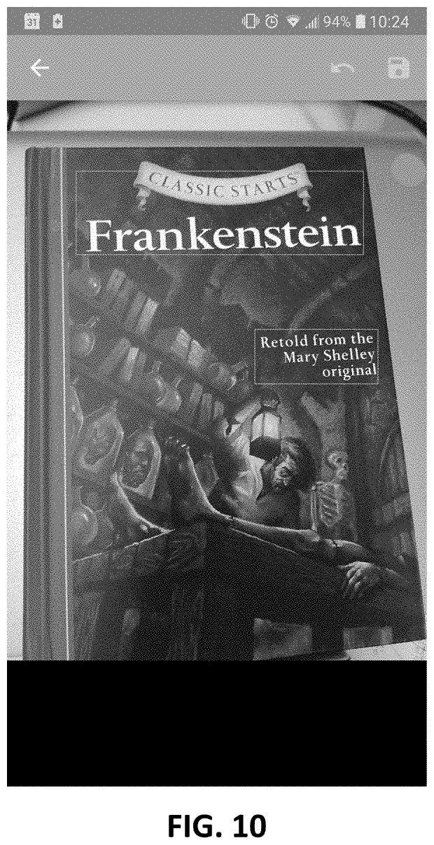

FIG. 10 shows a confirmation interface from the application of FIG. 3. The content shown is an image of a book. A data provider has labeled two fields within the image. In this example, the field labels correspond to “Book Title” (in this case, “Frankenstein”) and “Book Author”. As can be seen, the confirmation interface allows the data provider to return to another interface (using the “Back” button at the top left), to reverse their most recent action (using the “Undo” button), and to save or upload the image (using the “Save/Upload” button). Note that, because the “Zoom” and “Draw” functions in this interface are missing, if the data provider wishes to adjust a label or add another label, they must return to the labeling interface of FIG. 9.

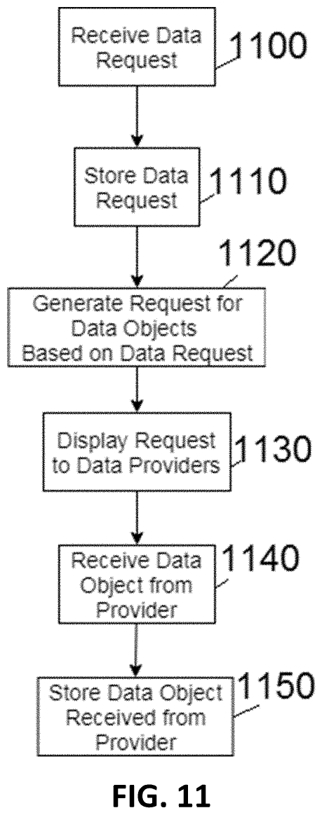

Referring now to FIG. 11, a flowchart detailing a method according to one aspect of the invention is shown. At step 1100, a data request for desired content is received from a data provider. The data request is stored at step 1110. Based on that data request, a request for data objects is generated at step 1120 and displayed to at least one data provider at step 1130. At step 1140, a data object is received from a data provider in response to that request. The data object is stored in an object database at step 1150.

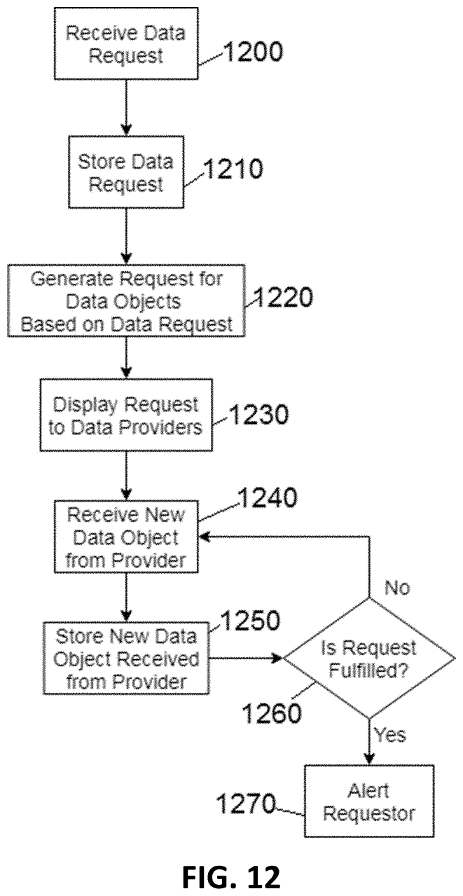

FIG. 12 is another flowchart, detailing another method of the invention. This method begins similarly to the method in FIG. 11: a data request is received at step 1200; that data request is stored at step 1210; and a request for data objects is generated at step 1220. At step 1230, the request for data objects is displayed to at least one data provider, and at step 1240, a new data object is received in response to the request. That new data object is stored at step 1250. As described above, this storing includes associating the data object with the data set that corresponds to the request. At step 1260, then, the data set is examined. If the data set is fulfilled (i.e., a desired number of data objects have been collected), the original requestor is alerted. However, if the data set is not yet fulfilled (i.e., not enough data objects have been collected), the method returns to step 1240 and another new data object is collected. This cycle repeats until the data set is fulfilled.

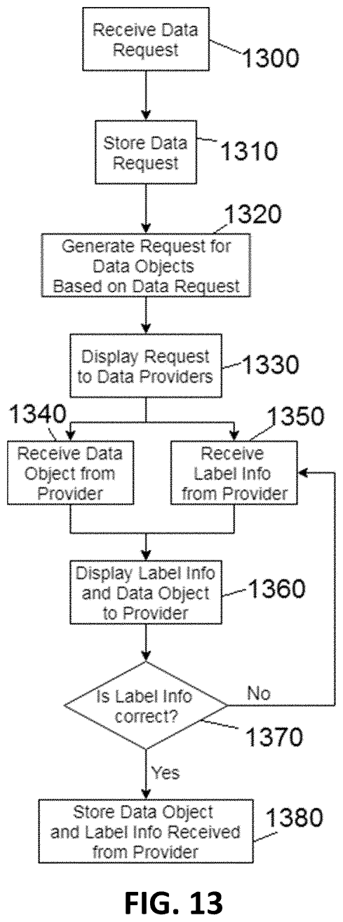

FIG. 13 is another flowchart, detailing another embodiment of the invention. In this embodiment, a data request for desired content is received at step 1300 and stored at step 1310. A request for data objects is generated at step 1320 and displayed to at least one data provider at step 1330. Then, at step 1340, a data object is received from a data provider. Additionally, label input information related to that data object is received at step 1350. The provided data object and the label input information are then displayed to the data provider at step 1360. At step 1370, the data provider is asked to confirm that the label input information is correct. If the information is correct, the data object and its associated label input information are stored in the object database, at step 1380. If the information is not correct, the data provider is permitted to modify the information and the method returns to step 1350.

It should be clear that the various aspects of the present invention may be implemented as software modules in an overall software system. As such, the present invention may thus take the form of computer executable instructions that, when executed, implements various software modules with predefined functions.

Additionally, it should be clear that, unless otherwise specified, any references herein to ‘image’ or to ‘images’ refer to a digital image or to digital images, comprising pixels or picture cells. Likewise, any references to an ‘audio file’ or to ‘audio files’ refer to digital audio files, unless otherwise specified. ‘Video’, ‘video files’, ‘data objects’, ‘data files’ and all other such terms should be taken to mean digital files and/or data objects, unless otherwise specified.

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g., “C” or “Go”) or an object-oriented language (e.g., “C++”, “java”, “PHP”, “PYTHON” or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

What is claimed is:

1. A method for collecting at least one data object containing desired content, steps comprising:
(a) receiving a data request for data objects containing said content;
(b) storing said data request in a first database;
(c) based on said data request, generating a request for said data objects;
(d) displaying said request for said data objects to at least one data provider;
(e) receiving said at least one data object from said at least one data provider in response to said request; and
(f) storing said data object in a second database.

2. The method according to claim 1, wherein said at least one data provider provides label input information to be associated with said at least one data object and said method further comprises the step of:
(g) enabling said at least one data provider to revise said label input information after said label input information has been provided.

3. The method according to claim 1, wherein steps (e) to (f) are iterated such that multiple data objects containing said content are collected, and wherein said method further comprises the step of grouping said multiple data objects together into a data set.

4. The method according to claim 3, further comprising the steps of:
(g) searching said second database for other data objects that are similar to said multiple data objects;
(h) adding said other data objects to said data set.

5. The method according to claim 3, wherein said data set is identified by a unique identifier and said multiple data objects are grouped into said data set by associating each of said multiple data objects with said unique identifier.

6. The method according to claim 3, wherein said data request comprises an amount request for at least one of: a specific number of said data objects; and a threshold number of said data objects.

7. The method according to claim 2, wherein said label input information includes at least one of: a label indicating a content type of said at least one data object; and at least one field label, wherein said at least one field label indicates a specific piece of data contained in said at least one data object.

8. The method according to claim 3, wherein said at least one data object is ranked based on at least one of: a quality of said at least one data object; and how many of said data objects have been collected.

9. The method according to claim 1, wherein said at least one data provider is incentivized to submit said at least one data object through an incentive program that provides at least one incentive to said at least one data provider.

10. The method according to claim 2, wherein said label input information replaces at least one piece of identifying data on said data object.

11. The method according to claim 1, wherein said at least one data provider obtains said at least one data object using a portable computing device.

12. The method according to claim 1, wherein said at least one data provider sets at least one permission level for said at least one data object, and wherein access to said at least one data object is based on said at least one permission level.

13. The method according to claim 1, wherein a data type of said data objects is at least one of:
text data;
image data;
image and text data;
audio data;
video data;
unidimensional data; and
multi-dimensional data.

14. A method for collecting at least one desired data object containing desired content, said method comprising the steps of:
(a) receiving a data request for data objects containing said desired content;
(b) storing said data request in a first database;
(c) searching a second database for at least one data object containing said desired content;
(d) retrieving said at least one data object from said second database;
wherein:
said at least one data object is provided by a data provider;
said at least one data object has at least one label; and
said at least one label indicates said a presence of said desired content in said at least one data object.

15. The method of claim 14, wherein said data provider sets at least one permission level for said at least one data object, and wherein access to said at least one data object is based on said at least one permission level.

16. A system for collecting at least one data object containing desired content, said system comprising:
a server for:
receiving a data request for data objects containing said desired content;
displaying a request for said data objects to at least one data provider;
receiving said at least one data object from said at least one data provider in response to said request;
a request database in operative communication with said server, said request database being for storing said data request; and an object database in operative communication with said server, said object database being for storing said at least one data object.

17. The system according to claim 16, wherein said server is in operative communication with a labeling module, said labeling module being for enabling said at least one data provider to associate label input information with said at least one data object and for enabling said at least one data provider to revise said label input information.

18. The system according to claim 16, wherein said data request comprises an amount request for at least one of: a specific number of said data objects; and a threshold number of said data objects.

19. The system according to claim 17, wherein said label input information includes at least one of: a label indicating a content type of said at least one data object; and at least one field label, wherein said at least one field label indicates a specific piece of data contained in said at least one data object.

20. The system according to claim 17, wherein said label input information replaces at least one piece of identifying data on said data object.

21. The system according to claim 16, wherein said at least one data provider obtains said at least one data object using a portable computing device, said portable computing device being in operative communication with said server.

22. The system according to claim 16, wherein a data type of said data objects is at least one of:
text data;
image data;
image and text data;
audio data;
video data;
unidimensional data; and
multi-dimensional data.
